(19) United States
(12) Patent Application Publication
(10) Pub. No.: US 2010/0231016 A1
(43) Pub. Date: Sep. 16, 2010

(54) VEHICLE SEAT

(75) Inventor: Reimer Võlz, Ruesselsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/721,135

(22) Filed: Mar. 10, 2010

(30) Foreign Application Priority Data
Mar. 11, 2009 (DE) 102009012739.9

(51) Int. Cl. B60N 2/42; A47C 7/14; B60N 2/02

(52) U.S. Cl. 297/217.1; 297/284.9

(57) ABSTRACT

In a vehicle seat, in particular for a motor vehicle, that includes, but is not limited to a seat surface, a backrest, at least one space in the area of the lateral supports of the seat surface and/or the backrest for the formation of at least one lateral seat support cushion. The space is sealed fluid-tight and variable in volume, and has at least one closing unit, e.g., a valve, for the controlled introduction and release of air into and from the space so as to vary the volume of the space, a cost-effective variable level of lateral support for the vehicle seat is to be enabled at a low technical outlay. This object is achieved by having the space incorporates a flexible body.

### CROSS-REFERENCE TO RELATED APPLICATION

This application claims priority to German Patent Application No. 102009012739.9, filed Mar. 11, 2009, which is incorporated herein by reference in its entirety.

### TECHNICAL FIELD

The present invention relates to a vehicle seat and further relates to a motor vehicle according.

### BACKGROUND

In motor vehicles, different driving conditions are encountered while driving, e.g., curves, so that high transverse forces and transverse accelerations act on passengers in the motor vehicle. In particular the driver and front-seat passenger in a motor vehicle must not leave the prescribed position on the vehicle seat when driving on curves. In order to counter the arising transverse accelerations on curves, the passengers in a motor vehicle must use muscle power to compensate for the arising forces.

Known in the art are “normal” vehicle seats with lateral seat support cushions. To this end, the sidewalls are each provided with lateral seat support cushions at the seating surfaces and backrest surfaces. However, the lateral seat support cushions are uncomfortable in the absence of transverse accelerations, e.g., while driving straight, and further get in the way of entering and exiting the motor vehicle.

Known in the art for this reason is to make the lateral seat support cushions variable in size for vehicle seats. To this end, the lateral seat support cushions are designed as aircushions, which can be inflated by a compressor. A closing unit makes it possible to control the process of increasing or decreasing the volume of the aircushion. Acceleration sensors or steer angle sensors acquire the arising transverse accelerations, and the aircushion of the lateral seat support cushion is inflated at a specific, prescribed transverse acceleration in order to increase the level of lateral support provided by the vehicle seat. At little or no arising transverse accelerations, the closing unit is used to release air from the aircushion, thereby substantially reducing the volume of the lateral seat support cushion or size of the lateral seat support cushion. However, in a fully automatic vehicle seat, this disadvantageously requires a high technical outlay, since a compressor is required for inflating the aircushions of the lateral seat support cushions.

DE 40 34 121 A1 shows a vehicle seat with self-inflating cushions in the sidewalls of the seat surfaces and the backrest. Valves can be used to adjust the quantity of air in the cushions. A disadvantage is that a compressor is required for inflating the cushions.

For this reason, at least one object of the present invention is to provide a vehicle seat and a motor vehicle that cost-effectively enable a variable level of lateral support for the vehicle seat at a low technical outlay. In addition, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics, are achieved with a vehicle seat, in particular for a motor vehicle, comprising a seat surface, a backrest, at least one space in the area of the lateral supports of the seat surface and/or the backrest for the formation of at least one lateral seat support cushion, wherein the space is sealed fluid-tight and variable in volume, and has at least one closing unit, e.g., a valve, for the controlled introduction and release of air into and from the space so as to vary the volume of the space, wherein the space incorporates a flexible body.

The flexible body makes it possible for the lateral seat support cushion to harden given with the closing unit closed, since no air can exit the space. As a result, the lateral seat support cushion can provide very good lateral support, even when high transverse forces are encountered. When the closing unit is open, the lateral seat support cushion is soft or flexible, so that the latter makes it possible to sit comfortably in the vehicle seat, in addition to which the lateral seat support cushion poses essentially no impediment when getting in and out of the motor vehicle. Therefore, the lateral seat support cushion deforms when corresponding forces arise on the lateral seat support cushion, and air can be introduced back into the space as the flexible body recovers its shape, without the necessity for an expensive compacting device, e.g., a compressor.

It is best that the closing unit be controllable in such a way that, when the required level of lateral support is higher than a prescribed level of lateral support, less or no air per unit of time can be released and preferably introduced from the space given a specific pressure difference between the space and the environment than given less or no required lateral support by comparison to the prescribed level of lateral support.

The level of required lateral support is determined by sensors, e.g., acceleration and/or steer angle sensors and/or velocity sensors, and preferably by means of an evaluator unit. The evaluator unit evaluates the data acquired by the at least one sensor, and determines the level of required lateral support.

A prescribed level of required lateral support is further stipulated. For example, the level of required lateral support depends on parameters such as the velocity of the motor vehicle and/or steer angle and/or acceleration, in particular transverse acceleration. If the level of required lateral support provided by the vehicle seat to the passenger is greater on the vehicle seat than the prescribed level of lateral support, it is necessary that the level of lateral support provided by the vehicle seat be increased by appropriately controlling the closing unit. The lateral seat support cushion gets harder, because only little of any air can escape the space. This increases the lateral support of the lateral seat support cushion. The closing unit, in particular a valve, is completely or partially closed when the level of required lateral support is greater than the prescribed level of required lateral support. By contrast, the valve is opened or completely opened once the level of required lateral support is smaller than the prescribed level of lateral support. Given an opened or nearly completely opened valve, the lateral seat support cushion is hence soft and readily deformable.

In particular, the closing unit can be controlled to the extent that no air can be released from the space or in preferably introduced into it given a higher level of required lateral support than the prescribed level of lateral support, and hat air can be introduced and released into and from the space given a smaller level of required lateral support than the prescribed level of lateral support. The closing unit is hence closed given a higher level of required lateral support than the prescribed level of lateral support, while the closing unit is hence open given a lower level of required lateral support than the prescribed level of lateral support.

In a supplementary embodiment, the space is enveloped in a fluid-tight manner by a membrane, e.g., a film, and/or the volume of the space is variable and/or the space is essentially filled completely by the flexible body. Essentially means that at least approximately 70% of the volume of the space is filled by the flexible body.

Given an elastic deformation and reduction of the volume of the flexible body, air can preferably be released from the space and/or introduced into the space via the resilient recovery of shape and increase in volume of the flexible body.

In one variant, an additional check valve can be used to introduce air exclusively into the space, in particular when the level of required lateral support is higher than the prescribed level of lateral support. An additional check valve to enhance the closing unit makes it possible to introduce air into the space at any time. Even if the closing unit is completely closed, e.g., if the level of required lateral support is higher than the prescribed level of lateral support, for example when traveling fast around curves, air can hence be introduced into the space. For example, this is advantageous in cases where only the left lateral seat support cushions are required while driving on a curvy road, while the right lateral seat support cushions are not required, wherein the volume of the space in the right lateral seat support cushion does not measure the maximum possible volume of the space, since air has streamed out of the space or the flexible body has deformed because the right lateral seat support cushion has been pressed in. As a result, the right lateral seat support cushions can increase in volume, thereby enabling a higher lateral support. The reverse also holds true. The check valve and the at least one closing unit can also be identical, in that the at least one closing unit is controlled in such a way as to satisfy the function of the check valve described above.

In one variant, the flexible body consists of foam and/or at least one spring, in particular a spiral spring. The advantage to foam or similar materials is that the latter are cheap to manufacture, while ensuring comfortable and uniform padding for passengers on the vehicle seat.

In another embodiment, air can be introduced into the space via a compacting device, e.g., a compressor, if the level of required lateral support is higher than the prescribed level of lateral support. An additional compacting device makes it possible to actively introduce air into the space if the level of required lateral support is higher than the prescribed level of lateral support. As a result, the lateral seat support cushion can also be enlarged to counter the force of a vehicle passenger sitting on the lateral seat support cushion.

A motor vehicle according to an embodiment of the invention comprising at least one vehicle seat, at least one sensor for acquiring a level of required lateral support for a vehicle passenger on the vehicle seat, and an evaluator unit to evaluate the data acquired by the sensor, wherein the vehicle seat is designed according to a vehicle seat described in this application.

In particular, the sensor is a steer angle sensor and/or a velocity sensor and/or an acceleration sensor and/or a sensor for acquiring the mass of a vehicle passenger situated on the vehicle seat.

In another embodiment, the data acquired by the sensor can be used by the evaluator unit to determine a level of required lateral support.

In a supplementary variant, the vehicle passenger can set the prescribed level of lateral support. To this end, the motor vehicle exhibits a control unit, e.g., a setting wheel or keys, with which the prescribed level of lateral support can be set. Vehicle passengers can use the latter to set the level of prescribed lateral support at which the lateral seat support cushions are activated. The lateral seat support cushions are hence activated starting at a certain transverse acceleration of the motor vehicle, for example, i.e., the closing unit is closed.

In another variant, the closing unit can be controlled in such a way given a level of required lateral support that is higher than the prescribed level of lateral support that, the higher the difference between the level of required lateral support and the prescribed level of lateral support, the lower the quantity of air that can be released from the space per unit of time given a specific pressure difference between the space and environment.

The greater the difference between the level of required lateral support and the prescribed level of lateral support, wherein the level of required lateral support is higher than the prescribed level of lateral support, the more the closing unit is closed. Given a very high level of required lateral support, the closing unit is hence nearly or completely closed, so that the lateral seat support cushion is very hard, and exhibits only slight resilient properties. Given an only slight level of required lateral support, for example which is only a little higher than the prescribed level of lateral support, the lateral seat support cushion still exhibits slight to moderate resilient properties. Therefore, the lateral seat support cushion adapts to the requirements placed on the level of required lateral support.

In another embodiment, the vehicle passenger can set the functional correlation between the difference between the level of required lateral support and the prescribed level of lateral support and the quantity of air that can be released from the space per unit of time given a specific pressure difference between the space and environment.

It is expedient to use a compacting device, e.g., a compressor, to introduce air into the space once the level of required lateral support is higher than the prescribed level of lateral support.

In an additional variant, the at least one closing unit is controlled as the vehicle passenger gets out in such a way that at least one closing unit is closed and kept closed with a compressed flexible body, so that the at least one lateral seat support takes up a small volume. The at least one closing unit remains closed until a vehicle passenger gets in again. As a result, the small-volume, at least one lateral seat support cushion does not impede the entry of vehicle passengers. After entry, the at least one closing unit can be opened again. The at least one closing unit is controlled by the motor vehicle door position and/or a safety belt sensor in a safety belt lock and/or the ignition.

The level of lateral support is the level of lateral support that the vehicle seat can make available to the vehicle passenger based on the variable geometry and variable size of the at least one lateral seat support cushion. The prescribed level of lateral support indicates the level of required lateral support at which the level of lateral support of the vehicle seat must be increased.

### BRIEF DESCRIPTION OF THE DRAWINGS

The present invention will hereinafter be described in conjunction with the following drawing figures, wherein like numerals denote like elements, and:

FIG. 1 is a diagrammatic view of a vehicle seat with four lateral seat support cushions; and

FIG. 2 is a cross section of the seat surface of the vehicle seat according to FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

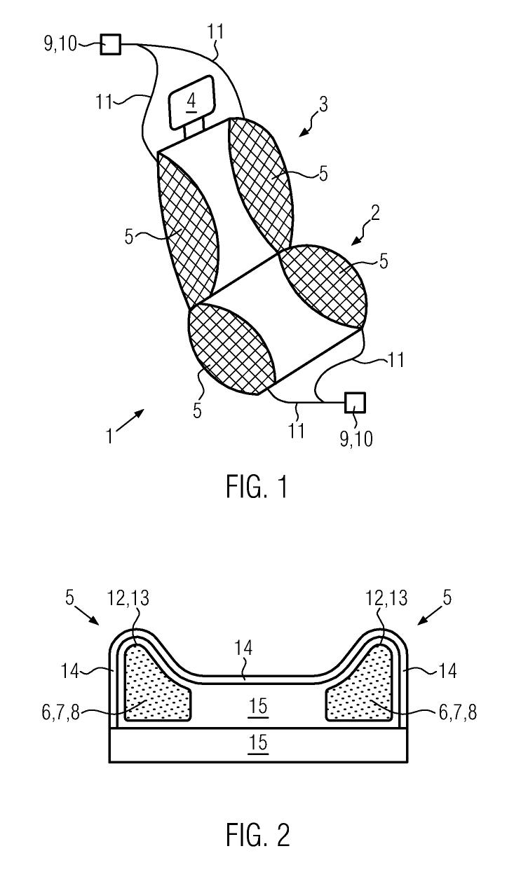

FIG. 1 presents a perspective view of a vehicle seat 1 for a motor vehicle with a seat surface 2 and a backrest 3. The vehicle seat 1 further exhibits a headrest 4. The vehicle seat 1 is secured in the interior cabin of a motor vehicle (not shown), and is used to accommodate vehicle passengers while the motor vehicle is traveling.

A respective lateral seat support cushion 5 is formed in the two lateral walls or end areas of the seat surface 2 and the backrest 3. The lateral seat support cushion 5 is hatched on FIG. 1. The lateral seat support cushions 5 exhibit an excess elevation relative to the remaining surface of the seat surface 2 or backrest 3, making it possible for the lateral seat support cushions 5 to hold a passenger on the vehicle seat 1 in the required position in the vehicle seat 1 during arising transverse accelerations. As a result, the vehicle passenger need not exert any high muscular force to offset arising transverse accelerations of the motor vehicle and remain in the required position on the vehicle seat. A cross section of the seat surface 2 of the vehicle seat 1 is shown on FIG. 2. The cross section of the backrest 3 is analogously designed. The surface of the seat surface 2 is comprised of a seat cover 14 made of fabric. The lateral seat support cushions 5 are comprised of a membrane 12 designed as a film 13, which envelops a space 6 in an airtight manner. The space 6 is essentially filled completely by a flexible body 7. The flexible body 7 is foam 8 comprised of plastic. In addition, padding 15 is situated between the two spaces 6 and below the spaces 6. The two spaces 6 of the seat surface 2 enveloped by the film 13 are connected by two hose lines 11 with a valve 10 as the closing unit 9.

An acceleration sensor (not shown) acquires the arising transverse accelerations of the motor vehicle, and an evaluator unit uses the data of the acceleration sensor to determine the level of required lateral support for a vehicle passenger on the vehicle seat 1. If the level of required lateral support is higher than a prescribed level of lateral support, the valves 10 are closed. The prescribed level of lateral support can be set by the vehicle passenger, for example, or is automatically determined, e.g., by means of a sensor for acquiring the mass of the vehicle passenger.

A first valve 10 is allocated to the two lateral seat support cushions 5 of the seat surface 2, while another second valve 10 is allocated to the backrest. The valves 10 are here connected by the hose line 10 so as to carry fluid to the space 6 of the lateral seat support cushion 5. With the valves 10 closed, the pressure acting on the surface of the lateral seat support cushion 5 prevents the air from escaping the space 6 enveloped by the film 13, so that the lateral seat support cushions 5 harden, and provide the vehicle passenger sufficient lateral support given arising transverse accelerations. As a result, the vehicle passenger is securely held in the vehicle seat 1 even when taking fast curves.

With the valves 10 open, air in the space 6 can both exit and enter the space 6 through the hose lines 11. The valves 10 are opened when the level of required lateral support is lower than the prescribed level of lateral support. For example, during straight ahead travel or when taking slight curves at a low speed, the valves 10 are open. The valves 10 are also open when the motor vehicle is not moving. When the valves 10 are open, the foam 8 in the space 6 behaves as normal foam 8, i.e., the lateral seat support cushion 5 can normally deform when exposed to pressure. The vehicle passenger than regard the lateral seat support cushions 5 as soft parts enabling a high level of comfort in the vehicle seat. The lateral seat support cushions 5 also deform in a readily resilient manner due to the ability of air to stream into and out of the space, so that the lateral seat support cushions 5 also essentially do not impede getting in and out of the motor vehicle. With the valves 10 open, the air streams out of the space 6 in response to a pressure exerted on the lateral seat support cushions 5. The foam 8 elastically deforms in the process. Once no more pressure is exerted on the lateral seat support cushions, the foam 8 recovers in a resilient manner, and the elastic recovery of the foam 8 also increases the volume of the space 6, allowing air to again stream into the space 6 through the hose lines 11.

In another exemplary embodiment (not shown), the vehicle seat 1 is additionally provided with a compacting device, e.g., a compressor. The compacting device makes it possible to actively introduce air into the space 6 even if a force is being exerted on the surface of the lateral seat support cushions 5. The compacting device is activated or switched on when the level of required lateral support is higher than the prescribed level of lateral support. As a result, the lateral seat support cushions 5 can be inflated to the maximum possible volume of the space 6, even if vehicle passengers are exerting higher pressures on the lateral seat support cushions 5. The semi-automatic vehicle seat 1 according to the exemplary embodiment on FIG. 1 and FIG. 2 can hence be converted from a semi-automatic vehicle seat 1 into a fully-automatic vehicle seat 1 without any significant structural changes by adding a compacting device.

Viewed as a whole, the vehicle seat 1 according to an embodiment of the invention is associated with considerable advantages. The semi-automatic vehicle seat 1 makes it possible to adjust the size and hardness of the lateral seat support cushions 5 without an expensive compacting device. As a result, just simple technical means—flexible foam 8, hose lines 11 and valves 100—can be used to provide a semi-automatic vehicle seat 1 for adjustment to the level of required lateral support. Integrating the lateral seat support cushion 5 filled with foam 8 into the vehicle seat 1 gives rise to the semi-automatic vehicle seat 1 with emergency running properties as opposed to a fully automatic vehicle seat 1 with lateral seat support cushions 5 filled only with air. A defect or leak in the film 13 is not accompanied by a total failure.

A normal vehicle seat 1 can be obtained without any substantial structural changes by omitting the hose lines 11 and valves 10. Therefore, the vehicle seat 1 can be manufactured with smaller technical changes as a normal vehicle seat 1 without any vehicle dynamics, as a semi-automatic vehicle seat with 1 with vehicle dynamics, and as a fully automatic vehicle seat 1 with vehicle dynamics.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A vehicle seat for a motor vehicle, comprising:
a seat surface;
a backrest;
at least one space that is present in an area of lateral supports of the seat surface or the backrest to form at least one lateral seat support cushion, wherein the at least one space is substantially sealed fluid-tight and variable in a volume;
at least one closing unit adapted for a controlled introduction and release of air into and from the at least one space so as to vary the volume of the at least one space; and
a flexible body is arranged in the at least one space.

2. The vehicle seat according to claim 1, wherein the at least one closing unit is adapted for control in such a way that when a required level of lateral support is higher than a prescribed level of lateral support, an at least reduced air per unit of time is adapted for release and introduction from the at least one space given a specific pressure difference between the at least one space and an environment than given at least required lateral support by comparison to the prescribed level of lateral support.

3. The vehicle seat according to claim 1, wherein the at least one closing unit is adapted for control in such a way that when a required level of lateral support is higher than a prescribed level of lateral support, substantially no air per unit of time can be released and introduced from the at least one space, and when the required level of lateral support is lower than the prescribed level of lateral support, air can be introduced and released from the at least one space.

4. The vehicle seat according to claim 1, wherein the at least one space is enveloped in a substantially fluid-tight manner by a membrane.

5. The vehicle seat according to claim 1, wherein given an elastic deformation and reduction of the volume of the flexible body and air can be released from the at least one space or introduced into the at least one space via a resilient recovery of shape and increase in the volume of the flexible body.

6. The vehicle seat according to claim 1, further comprising a check valve adapted to introduce air exclusively into the at least one space.

7. The vehicle seat according to claim 1, wherein the flexible body comprises foam.

8. The vehicle seat according to claim 1, further comprising a compacting device that is adapted to introduced air into the at least one space if a level of required lateral support is higher than a prescribed level of lateral support.

9. A motor vehicle, comprising:
at least one sensor adapted to acquire a level of required lateral support for a vehicle passenger;
an evaluator unit adapted to evaluate the level of required later support acquired by the at least one sensor; and vehicle seat adapted to support the vehicle passenger, the vehicle seat comprising:
a seat surface;
a backrest;
at least one space that is present in an area of lateral support of the seat surface or the backrest to form at least one lateral seat support cushion, wherein the at least one space is substantially sealed fluid-tight and variable in a volume;
at least one closing unit adapted for a controlled introduction and release of air into and from the at least one space so as to vary the volume of the at least one space; and
a flexible body is arranged in the at least one space.

10. The motor vehicle according to claim 9, wherein the at least one sensor is a steer angle sensor.

11. The motor vehicle according to claim 10, wherein data acquired by the at least one sensor can be used by the evaluator unit to determine the level of required lateral support.

12. The motor vehicle according to claim 9, wherein a prescribed level of lateral support is selectable.

13. The motor vehicle according to claim 9, wherein the at least one closing unit is adapted for control in such a manner given the level of required lateral support that is higher than a prescribed level of lateral support that when the higher a difference between the level of required lateral support and the prescribed level of lateral support, the lower a quantity of air that can be released from the at least one space and introduced per unit of time given a specific pressure difference between the at least one space and an environment.

14. The motor vehicle according to claim 13, wherein the vehicle passenger can set a functional correlation between the difference between the level of required lateral support and the prescribed level of lateral support and the quantity of air that can be released from the at least one space per unit of time given the specific pressure difference between the at least one space and the environment

15. The motor vehicle according to claim 9, wherein a compacting device is adapted to introduce air into the at least one space once the level of required lateral support is higher than a prescribed level of lateral support.

16. The vehicle seat according to claim 7, wherein the flexible body further comprises at least one spring.

17. The vehicle seat according to claim 16, wherein the at least one spring is a spiral spring.

18. The motor vehicle according to claim 9, wherein the at least one sensor is a velocity sensor.

19. The motor vehicle according to claim 9, wherein the at least one sensor is an acceleration sensor.

20. The motor vehicle according to claim 9, wherein the at least one sensor is a mass sensor for acquiring a mass of the vehicle passenger situated on the vehicle seat.
